(19) United States
(12) Patent Application Publication
(10) Pub. No.: US 2024/0378470 A1
(43) Pub. Date: Nov. 14, 2024

(54) Server and Agent for Reporting of Computational Results during an Iterative Learning Process

(71) Applicant: Telefonaktiebolaget LM Ericsson (publ), Stockholm (SE)

(72) Inventors: Henrik Rydén, Stockholm (SE); Reza Moosavi, Linköping (SE); Erik G. Larsson, Linköping (SE)

(21) Appl. No.: 18/692,362

(22) PCT Filed: Sep. 20, 2021
(86) PCT No.: PCT/EP2021/075742

§ 371 Date: Mar. 15, 2024

(51) Int. Cl. G06N 5/043; H04L 9/08

(52) U.S. Cl. CPC G06N 5/043; H04L 9/0819

(57) ABSTRACT

There is provided mechanisms for performing an iterative learning process with agent entities. A method is performed by a server entity. The method comprises associating a secret key with a computational task. The secret key defines a transform to be used by the agent entities when reporting computational results of the computational task to the server entity. The transform has an inverse. The method comprises configuring the agent entities with the computational task. The method comprises performing the iterative learning process with the agent entities until a termination criterion is met. The server entity as part of performing the iterative learning process applies the inverse of the transform to the computational results received from the agent entities.

### TECHNICAL FIELD

Embodiments presented herein relate to a method, a server entity, a computer program, and a computer program product for performing an iterative learning process with agent entities. Embodiments presented herein further relate to a method, an agent entity, a computer program, and a computer program product for performing an iterative learning process with a server entity.

### BACKGROUND

The increasing concerns for data privacy have motivated the consideration of collaborative machine learning systems with decentralized data where pieces of training data are stored and processed locally by edge user devices, such as user equipment. Federated learning (FL) is one non-limiting example of a decentralized learning topology, where multiple (possible very large number of) agents, for example implemented in user equipment, participate in training a shared global learning model by exchanging model updates with a centralized parameter server (PS), for example implemented in a network node.

FL is an iterative process where each global iteration, often referred to as communication round, is divided into three phases: In a first phase the PS broadcasts the current model parameter vector to all participating agents. In a second phase each of the agents performs one or several steps of a stochastic gradient descent (SGD) procedure on its own training data based on the current model parameter vector and obtains a model update. In a third phase the model updates from all agents are sent to the PS, which aggregates the received model updates and updates the parameter vector for the next iteration based on the model updates according to some aggregation rule. The first phase is then entered again but with the updated parameter vector as the current model parameter vector.

A common baseline scheme in FL is named Federated SGD, where in each local iteration, only one step of SGD is performed at each participating agent, and the model updates contain the gradient information. A natural extension is so-called Federated Averaging, where the model updates from the agents contain the updated parameter vector after performing their local iterations.

However, due to the broadcast nature of wireless communication, it could be that the model updates are sent from the agent towards the PS are intercepted by an eavesdropper. This could be an issue if the eavesdropper is able to extract sensitive information of one or more of the agents from the model updates. One way to potentially resolve this issue is to include the model updates in encrypted messages that are sent from the agents to the PS. The PS then needs to decrypt each and every message received from the agents before it can process the model updates (where the processing includes aggregating the received model updates and updating the parameter vector for the next iteration). Since there could be a large number of agents and each agent could send a large number of model updates, this would include considerable overhead and latency in the system. The overhead arises from the fact that the model updates are included in encrypted messages. The latency arises from the fact that the PS then needs to decrypt the messages received from each and every agent before it can process the model updates.

### SUMMARY

An object of embodiments herein is to address the above issues in order to enable secure communication between the agents (hereinafter denoted agent entities) and the PS (hereinafter denoted server entity) without increasing the communication latency or overhead.

According to a first aspect there is presented a method for performing an iterative learning process with agent entities. The method is performed by a server entity. The method comprises associating a secret key with a computational task. The secret key defines a transform to be used by the agent entities when reporting computational results of the computational task to the server entity. The transform has an inverse. The method comprises configuring the agent entities with the computational task. The method comprises performing the iterative learning process with the agent entities until a termination criterion is met. The server entity as part of performing the iterative learning process applies the inverse of the transform to the computational results received from the agent entities.

According to a second aspect there is presented a server entity for performing an iterative learning process with agent entities. The server entity comprises processing circuitry. The processing circuitry is configured to cause the server entity to associate a secret key with a computational task. The secret key defines a transform to be used by the agent entities when reporting computational results of the computational task to the server entity. The transform has an inverse. The processing circuitry is configured to cause the server entity to configure the agent entities with the computational task. The processing circuitry is configured to cause the server entity to perform the iterative learning process with the agent entities until a termination criterion is met. The server entity as part of performing the iterative learning process applies the inverse of the transform to the computational results received from the agent entities.

According to a third aspect there is presented a server entity for performing an iterative learning process with agent entities. The server entity comprises an associate module configured to associate a secret key with a computational task. The secret key defines a transform to be used by the agent entities when reporting computational results of the computational task to the server entity. The transform has an inverse. The server entity comprises a configure module configured to configure the agent entities with the computational task. The server entity comprises a process module configured to perform the iterative learning process with the agent entities until a termination criterion is met. The server entity as part of performing the iterative learning process applies the inverse of the transform to the computational results received from the agent entities.

According to a fourth aspect there is presented a computer program for performing an iterative learning process with agent entities. The computer program comprises computer program code which, when run on processing circuitry of a server entity, causes the server entity to perform a method according to the first aspect.

According to a fifth aspect there is presented a method for performing an iterative learning process with a server entity. The method is performed by an agent entity. The method comprises obtaining a secret key that is associated with a computational task. The secret key defines a transform to be used by the agent entity when reporting computational results of the computational task to the server entity. The method comprises obtaining configuring in terms of the computational task from the server entity. The method comprises performing the iterative learning process with the server entity until a termination criterion is met. The agent entity as part of performing the iterative learning process applies the transform to the computational results before sending the computational results to the server entity.

According to a sixth aspect there is presented an agent entity for performing an iterative learning process with a server entity. The agent entity comprises processing circuitry. The processing circuitry is configured to cause the agent entity to obtain a secret key that is associated with a computational task. The secret key defines a transform to be used by the agent entity when reporting computational results of the computational task to the server entity. The processing circuitry is configured to cause the agent entity to obtain configuring in terms of the computational task from the server entity. The processing circuitry is configured to cause the agent entity to perform the iterative learning process with the server entity until a termination criterion is met. The agent entity as part of performing the iterative learning process applies the transform to the computational results before sending the computational results to the server entity.

According to a seventh aspect there is presented an agent entity for performing an iterative learning process with a server entity. The agent entity comprises an obtain module configured to obtain a secret key that is associated with a computational task. The secret key defines a transform to be used by the agent entity when reporting computational results of the computational task to the server entity. The agent entity comprises an obtain module configured to obtain configuring in terms of the computational task from the server entity. The agent entity comprises a process module configured to obtain perform the iterative learning process with the server entity until a termination criterion is met. The agent entity as part of performing the iterative learning process applies the transform to the computational results before sending the computational results to the server entity.

According to an eighth aspect there is presented a computer program for performing an iterative learning process with a server entity, the computer program comprising computer program code which, when run on processing circuitry of an agent entity, causes the agent entity to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects enable secure communication between the agent entities and the server entity without the communication latency or overhead being increased.

Advantageously, these aspects make it impossible, or at least very difficult, for an eavesdropper to infer information about private data of any of the agent entities.

Advantageously, these aspects enable improved protection of sensitive information, such as geolocation information, raw image data, raw text data, etc. when such information is included in an iterative learning process.

Advantageously, these aspects enable improved protection of sensitive information, without the need for computationally expensive encryption techniques.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a signalling diagram according to an example;

FIG. 3 is a schematic illustration of a server entity, agent entities, and an eavesdropper according to embodiments;

FIGS. 4, 5, 6, and 7 are flowcharts of methods according to embodiments;

FIG. 8 is a signalling diagram according to an embodiment;

FIG. 9 is a schematic diagram showing functional units of a server entity according to an embodiment;

FIG. 10 is a schematic diagram showing functional modules of a server entity according to an embodiment;

FIG. 11 is a schematic diagram showing functional units of an agent entity according to an embodiment;

FIG. 12 is a schematic diagram showing functional modules of an agent entity according to an embodiment;

FIG. 13 shows one example of a computer program product comprising computer readable means according to an embodiment;

FIG. 14 is a schematic diagram illustrating a telecommunication network connected via an intermediate network to a host computer in accordance with some embodiments; and

FIG. 15 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item, piece of information, etc. is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item, piece of information, etc. is provided by a first device to a second device should be construed as that data item or piece of information being sent or otherwise made available to the second device by the first device. For example, the data item or piece of information might either be pushed to the second device from the first device or pulled by the second device from the first device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

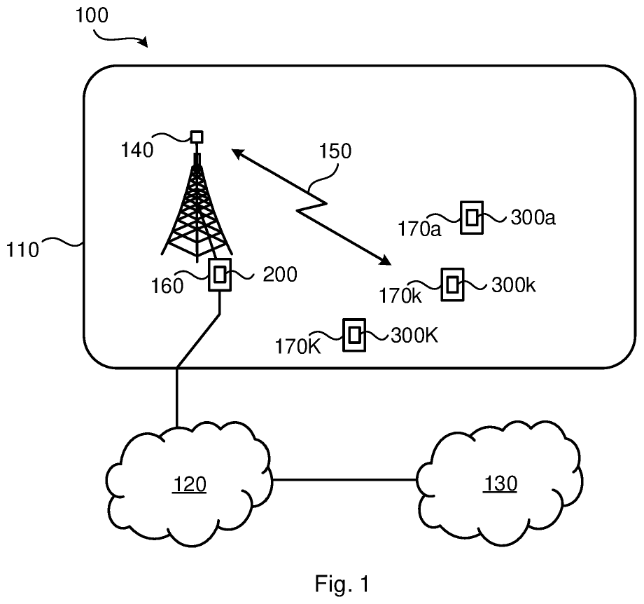

FIG. 1 is a schematic diagram illustrating a communication network 100 where embodiments presented herein can be applied. The communication network 100 could be a third generation (3G) telecommunications network, a fourth generation (4G) telecommunications network, a fifth (5G) telecommunications network, a sixth (6G) telecommunications network, and support any 3GPP telecommunications standard.

The communication network 100 comprises a transmission and reception point 140 configured to provide network access to user equipment 170a, 170k, 170K in an (radio) access network 110 over a radio propagation channel 150. The access network 110 is operatively connected to a core network 120. The core network 120 is in turn operatively connected to a service network 130, such as the Internet.

The user equipment 170a:170K is thereby, via the transmission and reception point 140, enabled to access services of, and exchange data with, the service network 130.

Operation of the transmission and reception point 140 is controlled by a network node 160. The network node 160 might be part of, collocated with, or integrated with the transmission and reception point 140.

Examples of network nodes 160 are (radio) access network nodes, radio base stations, base transceiver stations, Node Bs (NBs), evolved Node Bs (eNBs), gNBs, access points, access nodes, and integrated access and backhaul nodes. Examples of user equipment 170a:170K are wireless devices, mobile stations, mobile phones, handsets, wireless local loop phones, smartphones, laptop computers, tablet computers, network equipped sensors, network equipped vehicles, and so-called Internet of Things devices.

It is assumed that the user equipment 170a:170K are to be utilized during an iterative learning process and that the user equipment 170a:170K as part of performing the iterative learning process are to report computational results to the network node 160. The network node 160 therefore comprises, is collocated with, or integrated with, a server entity 200. Each of the user equipment 170a:170K comprises, is collocated with, or integrated with, a respective agent entity 300a:300K.

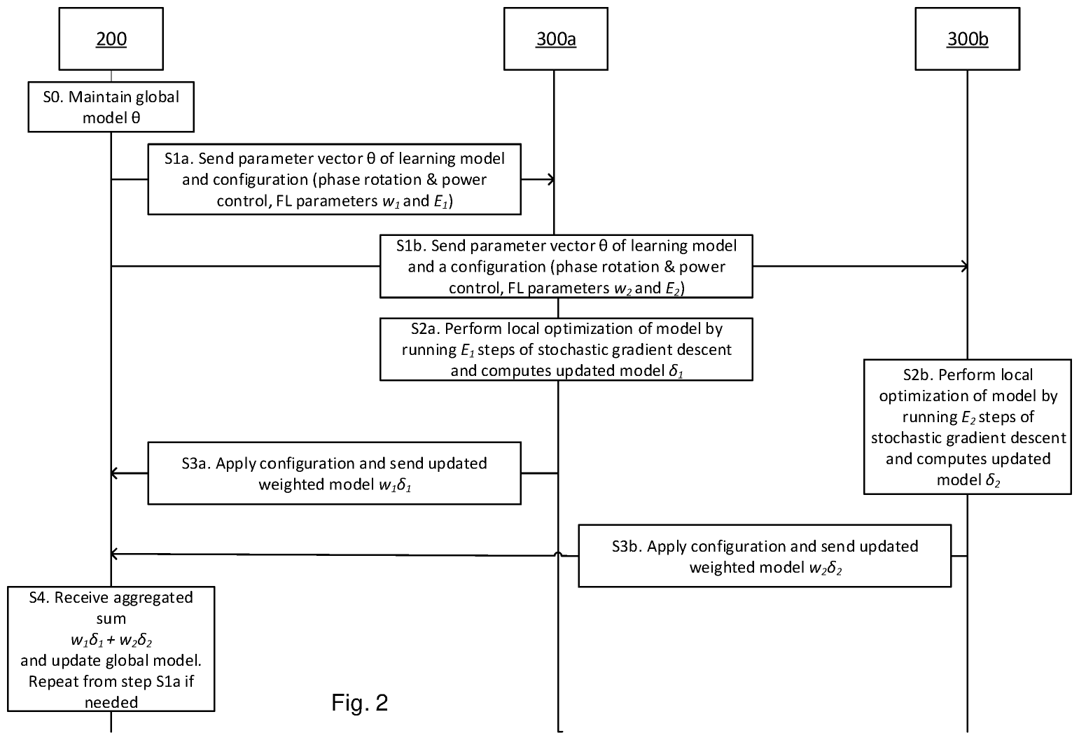

Reference is next made to the signalling diagram of FIG. 2, illustrating an examples of a nominal iterative learning process. For simplicity, but without loss of generality, the example is shown for two agent entities 300a, 300b, but the principles hold also for larger number of agent entities 300a:300K.

The server entity 200 updates its estimate of the learning model (maintained as a global model θ in step S0), as defined by a parameter vector θ(i), by performing global iterations with an iteration time index i. The parameter vector θ(i) is assumed to be an N-dimensional vector. At each iteration i, the following steps are performed:

Steps S1a, S1b: The server entity 200 broadcasts the current parameter vector of the learning model, θ(i), to the agent entities 300a, 300b.

Steps S2a, S2b: Each agent entity 300a, 300b performs a local optimization of the model by running T steps of a stochastic gradient descent update on θ(i), based on its local training data;

$${θ}_{k} ( i , τ ) = {θ}_{k} ( i , τ - 1 ) - {η}_{k} ∇ {f}_{k} ( {θ}_{k} ( i , τ - 1 ) ) , τ = 1 , … , T ,$$

where ηₖ is a weight and ƒₖ is the objective function used at agent entity k (and which is based on its locally available training data).

Steps S3a, S3b: Each agent entity 300a, 300b transmits to the server entity 200 their model update δₖ(i);

$${δ}_{k} ( i ) = {θ}_{k} ( i , T ) - {θ}_{k} ( i , 0 ) ,$$

where θₖ(i, 0) is the model that agent entity k received from the server entity 200. Steps S3a, S3b may be performed sequentially, in any order, or simultaneously.

Step S4: The server entity 200 updates its estimate of the parameter vector θ(i) by adding to it a linear combination (weighted sum) of the updates received from the agent entities 300a, 300b;

$$θ ( i + 1 ) = θ ( i ) + {w}_{1} {δ}_{1} ( i ) + {w}_{2} {δ}_{2} ( i )$$

where wₖ are weights.

Assume now that there are K agent entities and hence K model updates. When the model updates {δ₁, . . . , δ_{K}} (where the time index has been dropped for simplicity) from the agent entities 300a:300K over a wireless communication channel, there are specific benefits of using direct analog modulation. For analog modulation, the k:th agent entity could transmit the N components of δₖ directly over N resource elements (REs). Here an RE could be, for example: (i) one sample in time in a single-carrier system, or (ii) one subcarrier in one orthogonal frequency-division multiplexing (OFDM) symbol in a multicarrier system, or (iii) a particular spatial beam or a combination of a beam and a time/frequency resource.

One benefit of direct analog modulation is that the superposition nature of the wireless communication channel can be exploited to compute the aggregated update, δ₁+δ₂+ . . . +δ_{K}. More specifically, rather than sending δ₁, . . . , δ_{K} to the server entity 200 on separate channels, the agent entities 300a:300K could send the model updates {δ₁, . . . , δ_{K}} simultaneously, using N REs, through linear analog modulation. The server entity 200 could then exploit the wave superposition property of the wireless communication channel, namely that {δ₁, . . . , δ_{K}} add up “in the air”. Neglecting noise and interference, the server entity 200 would thus receive the linear sum, δ₁+δ₂+ . . . +δ_{K}, as desired. That is, the server entity 200 ultimately is interested only in the aggregated model update δ₁+δ₂+. . . +δ_{K}, but not in each individual parameter vector {δ₁, . . . , δ_{K}}.

The over-the-air computation assumes that appropriate power control is applied (such that all transmissions of {δₖ} are received at the server entity 200 with the same power), and that each transmitted δₖ is appropriately phase-rotated prior to transmission to pre-compensate for the phase rotation incurred by the channel from agent entity k to the server entity 200.

One benefit of the thus described over-the-air computation is the savings of radio resources. With two agents (K=2), 50% resources are saved compared to standard FL since the two agent entities can send their model updates simultaneously in the same RE. With K agent entities, only a fraction 1/K of the nominally required resources are needed.

As disclosed above, there could be scenarios where a potential eaves dropper could overhear transmissions of the model updates from the agent entities 300a:300K to the server entity 200 and therefrom extract sensitive information. As a non-limiting illustrative example, consider a scenario with one server entity 200 and two agent entities, indexed by k=1, 2, transmitting gradient updates δ₁ and δ₂, targeting a server entity 200 that relies on over-the-air computation. Furthermore, consider an eavesdropper located somewhere in the environment, with the intent of secretly listening to the transmissions from one or more of the agent entities. Assume that the eavesdropper will receive the signal aδ₁+bδ₂ where a and b are coefficients that depend on the wireless propagation environment (neglecting additive receiver noise). Specifically, if the eavesdropper is physically closer to, say, agent entity 1 than agent entity 2, then |a|>>|b|, and the eavesdropper will receive substantially only aδ₁. This means that the eavesdropper might obtain an accurate estimate of δ₁. Based on δ₁, the eavesdropper might infer information about the private training data of agent entity 1 through gradient leakage.

Three illustrative examples of how the eavesdropper might infer sensitive information will now be disclosed.

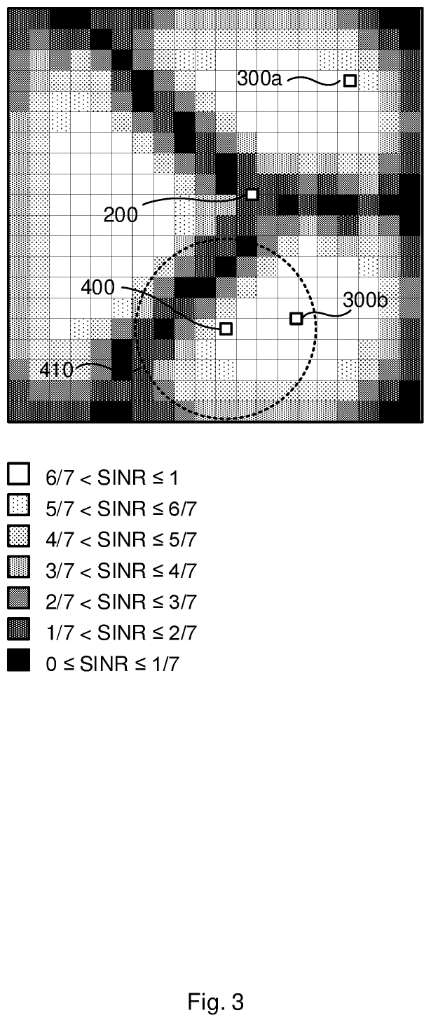

According to a first example, the iterative learning procedure concerns mapping one or more geolocations to a radio signal quality values, or bitrate values. This can be used by the network to create an understanding of potential network coverage holes in a cell, and how the bitrate varies within the cell. However, a UE-reported geolocation can violate privacy concerns of the user equipment, and therefore an iterative learning procedure can be used since it only comprises signaling of parameter vectors. One example of this is shown in FIG. 3, where two agent entities 300a, 300b have a dataset of geolocation to Signal-to-Interference-plus-Noise Ratio (SINR) mappings according to each respective dotted area (where the SINR takes a normalized value from 0 to 1). The two agent entities 300a, 300b then perform an iterative learning procedure with the server entity 200 in order to include their dataset information in a global model to be used by the network. An eavesdropper 400 is assumed to be able to overhear transmission within a circle 410 and thus the transmission from agent entity 300b. The eavesdropper 400 can then, as has been previously disclosed, accurately estimate the parameter vectors reported by agent entity 300b and use gradient leakage techniques to estimate the geolocations visited by agent entity 300b.

According to a second example, the iterative learning procedure concerns surveillance, using a network of cameras, of a particular area public or private). Each camera is associated with its own agent entity 300a:300K. The network is configured to learn a global model that can be used to detect whether suspicious activity is ongoing in any of the video imagery as captured by the cameras. The suspicious activity could pertain to identifying unauthorized persons present in a private area, identifying vehicles in the area, or monitoring the area for any criminal activity. The cameras however, for privacy reasons, are not allowed to share their raw image data. An iterative learning procedure can then be used to train the global model, where the cameras share only model (gradient) updates in terms of parameter vectors, rather than their observations. In this case the parameter vectors might represent predictions of the content in the images (for examples, parameters of a face recognition algorithm). An eavesdropper 400 could, from the parameter vectors of one of the agent entities, learn information about the individual imagery from the camera associated with this one of the agent entities 300a:300K and therefrom reveal the identity of a physical person having been captured in the images from one or more of the cameras. This could thus compromise the privacy of, for example, a physical person or vehicle in the area.

According to a third example, the iterative learning procedure concerns a natural language processing application. The agent entities 300a:300K could collaborate to learn a language model, for example for text prediction when typing on a user equipment, such as a mobile device, where each of the agent entities 300a:300K thus could be associated with their own user equipment. Using an iterative learning procedure, only updates to the model need to be shared, but raw text data will not be shared. An eavesdropper 400 could, from the parameter vectors of one of the agent entities, learn information about the raw text as inputted by the user of the user equipment associated with this one of the agent entities 300a:300K and therefrom deduce, or extract, sensitive information.

At least some of the herein disclosed embodiments are therefore based on that a secret key is shared between the server entity 200 and all participating agent entities 300a:300K. The agent entities 300a:300K could then be configured to apply an invertible transformation to their model updates, where the transformation is defined by the secret key, before sending the model updates to the server entity 200. The server entity 200, upon reception of model updates, could then invert the received transformed model updates by applying the inverse of the transformation to the received (transformed) model updates. The agent entity could then perform global averaging, and update the global model accordingly.

The embodiments disclosed herein therefore relate to mechanisms for performing an iterative learning process with agent entities 300a:300K and performing an iterative learning process with a server entity 200. In order to obtain such mechanisms there is provided a server entity 200, a method performed by the server entity 200, a computer program product comprising code, for example in the form of a computer program, that when run on processing circuitry of the server entity 200, causes the server entity 200 to perform the method. In order to obtain such mechanisms there is further provided an agent entity 300k, a method performed by the agent entity 300k, and a computer program product comprising code, for example in the form of a computer program, that when run on processing circuitry of the agent entity 300k, causes the agent entity 300k to perform the method.

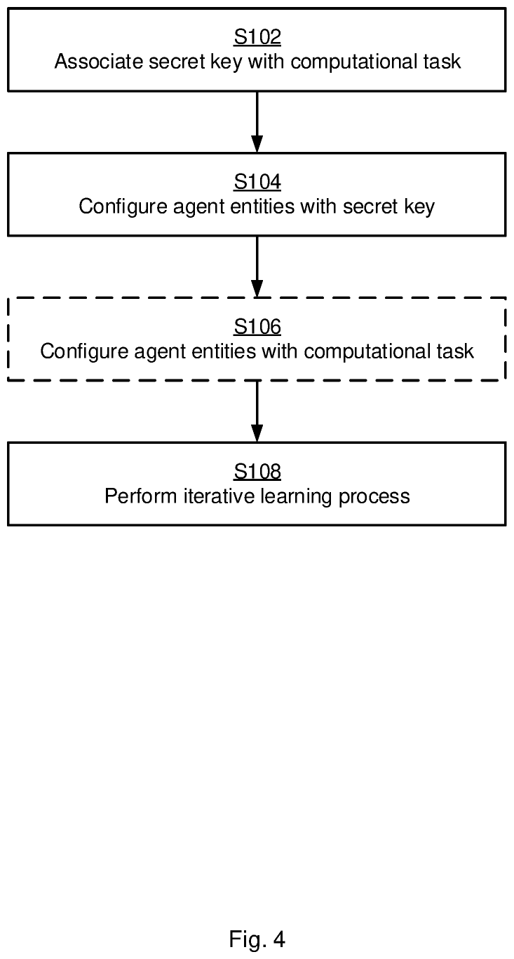

Reference is now made to FIG. 4 illustrating a method for performing an iterative learning process with agent entities 300a:300K as performed by the server entity 200 according to an embodiment.

S102: The server entity 200 associates a secret key [symbol] with a computational task. The secret key [symbol] defines a transform Tₖ to be used by the agent entities 300a:300K when reporting computational results of the computational task to the server entity 200. The transform Tₖ has an inverse Tₖ⁻¹.

That the secret key [symbol] is associated with the computational task implies that the secret key [symbol] has a logic connection, or logic link, to the computational task and hence that the secret key [symbol] (by means of the transform Tₖ and its inverse Tₖ⁻¹ that both are defined by the secret key [symbol] ) is to be used when the computational results of the computational task are reported. Further, if there are several computational tasks, each computational task can have its own associated secret key [symbol] and hence a respective transform can be used by the agent entities 300a:300K when reporting computational results of each computational task (i.e., one transform per computational task).

S106: The server entity 200 configures the agent entities 300a:300K with the computational task.

S108: The server entity 200 performs the iterative learning process with the agent entities 300a:300K until a termination criterion is met. The server entity 200 as part of performing the iterative learning process applies the inverse Tₖ⁻¹ of the transform Tₖ to the computational results received from the agent entities 300a:300K.

Embodiments relating to further details of performing an iterative learning process with agent entities 300a:300K as performed by the server entity 200 will now be disclosed.

The termination criterion in some non-limiting examples can be when a pre-determined number of iterations have been reached or when the computational results differ less than a threshold value from one iteration to the next.

Aspects of how the secret key [symbol] might be generated and shared will now be disclosed.

In some aspects, the secret key [symbol] is determined using a pseudo-random mechanism. Particularly, in some embodiments, the secret key [symbol] is generated using a pseudo-random mechanism.

In some non-limiting examples, the secret key [symbol] is a function of any of: a pseudo-random number, identifiers of user equipment 170a:170K in which the agent entities 300a:300K are provided, randomness extracted from hardware of a network node 160 in which the server entity 200 is provided, a time-stamp, or any combination thereof. In this respect, the identifier might be an international mobile subscriber identity (IMSI) or a radio network temporary identifier (RNTI), or a group RNTI (for which a power control command is issued). In wireless communication systems, the RNTI can be used to generate a pseudo-random sequence, where the sequence is used by the user equipment to generate a reference signal to be transmitted from the user equipment. In some wireless communication systems such a reference signal might be generated using a Zadoff-Chu sequence. In particular, in some embodiments, the secret key [symbol] defines a sequential pattern of values to be applied by the agent entities 300a:300K to the computational results, and the transform Tₖ is represented by the sequential pattern of values.

In some aspects, the secret key [symbol] assumes one out of a finite number of values, and can therefore be represented by a positive integer. Henceforth it might thus be assumed that the secret key [symbol] can take a value from 1 up to a largest possible value | [symbol] |. For example, with a 256-bit key [symbol] , [ [symbol] ]=2²⁵⁶.

In some aspects, the sharing of the secret key is achieved by the agent entity 200 sending the secret key to the agent entities 300a:300K using any available public-key cryptography techniques. For example, the agent entity 200 may determine the secret key [symbol] , set up a secure channel to the agent entities 300a:300K, and then send the secret key [symbol] to the agent entities 300a:300K over this secure channel. Hence, in some embodiments, the server entity 200 is configured to perform (optional) step S104:

S104: The server entity 200 configures the agent entities 300a:300K with the secret key [symbol] over a secure channel established between the server entity 200 and the agent entities 300a:300K.

The secret channel might be established using any radio access technology available to both the server entity 200 (or a network node 160 in which the server entity 200 is provided) and the agent entities 300a:300K (or user equipment 170a:170K in which the agent entities 300a:300K are provided). A potential eavesdropper 400 can thus deduce the secret key [symbol] since it is either transmitted over a secure channel or already preconfigured in each of the agent entities 300a:300K.

Aspects and properties of the transform Tₖ will now be disclosed.

In some aspects, the transform Tₖ is the same for all agents (k=1, 2, . . . , K). In some examples the transform is generated by a predefined group Radio Network Temporary Identifier (RNTI). In some examples the transform is based on a dedicated RNTI used specifically for the iterative learning procedure.

In some aspects, the transform Tₖ is linear and can be represented in terms of multiplication by an N×N matrix L. This matrix L must thus be invertible. Particularly, in some embodiments, the transform Tₖ is represented by a matrix Lₖ having an inverse Lₖ⁻¹. The computational results received from the agent entities 300a:300K can then by the server entity 200 be multiplied with the inverse Lₖ⁻¹ of the matrix Lk when the inverse Tₖ⁻¹ of the transform Tₖ is applied to the computational results. The matrix L is obtained from the secret key [symbol] through a pre-determined mapping. Examples of such mappings will be provided next.

In some embodiments, the matrix L is a permutation matrix. Let Ø(i) be a pre-determined function that maps an integer i ∈ 1, . . . , | [symbol] | onto a permutation over the set [1, . . . , N]. For example, Ø(i) can be constructed by enumerating all N! permutations i (e.g. in the order generated by Heap's algorithm) and then picking the (i mod | [symbol] |)+first permutation in the list. Let [Ø(i)]ₙ be the n:th element of Ø(i). The matrix L can then be constructed from the secret key [symbol] by setting its (n, [Ø(i)]ₙ):th element to one for n=1, . . . , N, and all other elements to zero. That is, in some embodiments, the matrix Lk is of size N×N and is generated as a function of the secret key [symbol] by setting element (n, [Ø(i)]ₙ)=1 in the matrix Lₖ, for n=1, . . . , N, and setting all other elements to 0. As an illustrative non-limiting example, for N=3 there are six possible permutation matrices (including the trivial identity matrix):

$$[ \begin{matrix}1 & 0 & 0 \\ 0 & 1 & 0 \\ 0 & 0 & 1\end{matrix} ] , [ \begin{matrix}1 & 0 & 0 \\ 0 & 0 & 1 \\ 0 & 1 & 0\end{matrix} ] , [ \begin{matrix}0 & 1 & 0 \\ 1 & 0 & 0 \\ 0 & 0 & 1\end{matrix} ] , [ \begin{matrix}0 & 1 & 0 \\ 0 & 0 & 1 \\ 1 & 0 & 0\end{matrix} ] , [ \begin{matrix}0 & 0 & 1 \\ 1 & 0 & 0 \\ 0 & 1 & 0\end{matrix} ] , [ \begin{matrix}0 & 0 & 1 \\ 0 & 1 & 0 \\ 1 & 0 & 0\end{matrix} ] .$$

From which Lk can be selected. If L is a permutation matrix then no explicit matrix arithmetic is required when multiplying the model update by L, but the permutation matrix still offers a versatile framework for enabling a linear transformation. In case matrix L is a permutation matrix, for a 256-bit key, the length of the parameter vectors N should be at least 58 (since 58 is the smallest integer ξ such that ξ!>2²⁵⁶). Otherwise an attacker might guess the permutation faster than exhaustive key search. Also, items in the N-dimensional vectors must be indistinguishable from each other, otherwise the attacker can collect statistics over the item values of each parameter vector and use a simple distinguisher to determine the permutation.

In some aspects, the matrix L is a an orthogonal matrix. The orthogonal matrix can be defined by the factor Q in a QR-factorization of a random matrix X. The random matrix X can be obtained through a pre-determined pseudo-random number generator seeded by the value of the secret key [symbol] , or alternatively, [symbol] mod I for some integer I that represents the largest possible seed value of the random number generator. As an illustrative non-limiting example, for N=3 and a random matrix X with values as follows:

$$X = [ \begin{matrix}0.5377 & 0.8622 & - 0.4336 \\ 1.8339 & 0.3188 & 0.3426 \\ - 2.2588 & - 1.3077 & 3.5784\end{matrix} ] ,$$

the matrix L will have values as follows:

$$L = [ \begin{matrix}- 0.1817 & 0.7236 & 0.6658 \\ - 0.6198 & - 0.6100 & 0.4938 \\ 0.7634 & - 0.3230 & 0.5594\end{matrix} ] .$$

In some examples, the matrix L is obtained from the secret key [symbol] through a pre-determined mapping. The predetermined mapping might be based on e.g., a Zadoff-Chu sequence generated by an RNTI.

In some aspects, the transform Tₖ involves adding pseudo-random noise zₖ, where zₖ is a vector of dimension N, to δₖ. Particularly, in some embodiments, the transform Tₖ defines a sequence zₖ of pseudo-random noise, seeded by the secret key [symbol] , to be added to the computational results by the agent entities 300a:300K. As an example, in the two-agent case, {zₖ} might be generated from the key [symbol] and the agent index k through a pre-determined mapping such that z₂=−z₁. Hence, in some embodiments, the sequence zₖ of pseudo-random noise for a first of the agent entities 300a:300K and for a second of the agent entities 300a:300K have identical values but with opposite signs. That is, the pseudo-random noises generated by the two agents are negatively correlated with correlation coefficient 1. Further, for the two-agent case, z₁ might be generated by using a pre-determined pseudo-random number generator configured to output random numbers with zero mean and variance σ and seeded by [symbol] mod I; looping over its elements (n=1, . . . , N); and for each n set the n:th element of z₁ to the output of the random number generator. Finally, set z₂=−z₁. In the general case with [symbol] agent entities, {zₖ} might be generated such that

$${\sum }_{k = 1}^{K} {z}_{k} = 0 .$$

Hence, in some embodiments, the sequences zₖ of pseudo-random noise for all the agent entities 300a:300K sum to zero. An example mechanism that generates {zₖ} is as follows. Loop over the N elements (n=1, . . . , N). For each element, generate [symbol] random numbers r₁, . . . , r_{K} using a pre-determined pseudo-random number generator seeded by the value of the secret key [symbol] . Let r̅=(1/ [symbol] )Σₖ₌₁^{K}rₖ be the arithmetic mean of {r₁, . . . , r_{K}}. Then, clearly, rₖ−r̅ sum up to zero. Set the n:th element of zₖ to rₖ−r̅. In some examples, the random number generator is configured to deliver

Gaussian distributed random numbers. In other examples, the random number generator is configured to deliver output with a symmetric alpha-stable distribution. In some examples, the value of o is adjusted to achieve a desired tradeoff between transmit power consumption and added protection to eavesdropping. In the present disclosure, the user equipment 170a:170K can be configured with a dedicated RNTI to be used when the agent entities 300a:300K participate in the iterative learning procedure. Such a dedicated RNTI can be used as an input to the Zadoff-Chu pseudo-random sequence function (or any other suitable pseudo-random sequence function), and the generated pseudo-random sequence can be used in order to create the pseudo-random noise {zₖ}. Two user equipment can be configured with the same RNTI but the agent entity of one of the user equipment should then scale its transmission with the factor −1 (such that z₂=−z₁).

In some aspects, applying the transform Tₖ involves a combination of two or more techniques as herein disclosed. For example, applying the transform Tₖ might involve a combination of linear transformation and adding pseudo-random noise. That is, the transform Tₖ might consist of a combination of multiplication with a matrix L and addition of pseudo-random noise zₖ. To illustrate this in detail, agent entity k might effectively transmit \sqrt{Pₖ}[L δₖ+zₖ] where Pₖ is a power control coefficient. Assuming that this power control coefficient is selected as the reciprocal path loss, the server entity 200 receives a signal proportional to:

$${\sum }_{k = 1}^{K} [ L {δ}_{k} + {z}_{k} ] = L {\sum }_{k = 1}^{K} {δ}_{k} ,$$

assuming that all zₖ sum to zero. The server entity 200, by knowledge of the secret key [symbol] , inverts L, and multiplies the received signal by L⁻¹ to recover δ₁+δ₂+ . . . +δ_{K}. The eavesdropper 400 could at best obtain L δₖ+zₖ, from which no information on the private training data of agent entity k can be inferred.

Aspects of when to activate the herein disclosed techniques for transforming the model updates at the agent entities 300a:300K will now be disclosed. In relation thereto, further aspects of the iterative learning process will also be disclosed. Intermediate reference is here made to the flowchart of FIG. 5 showing optional steps of one iteration of the iterative learning process that might be performed by the server entity 200 during each iteration of the iterative learning process in S108.

S108b: The server entity 200 provides a parameter vector of the computational task to the agent entities 300a:300K.

S108c: The server entity 200 receives the computational results as a function of the parameter vector from the agent entities 300a:300K.

S108d: The server entity 200 obtains inverse transformed computational results by applying the inverse Tₖ⁻¹ of the transform Tₖ to the computational results.

S108e: The server entity 200 updates the parameter vector as a function of an aggregate of the inverse transformed computational results.

In some aspects, the secret key [symbol] is changed over time from one iteration of the iterative learning process to the next. Hence, in some embodiments, the server entity 200 is configured to perform (optional) step S108f as part of performing the iterative learning process in S108:

S108f: The server entity 200 updates the secret key [symbol] for a next iteration of the iterative learning process, whereby a new transform is defined. The new transform has a new inverse (compared to the inverse Tₖ⁻¹ of the transform Tₖ).

In some aspects, the secret key [symbol] is changed over time according to a pre-determined schedule. Particularly, in some embodiments, the secret key [symbol] is updated according to a pre-determined schedule known to the server entity 200 and the agent entities 300a:300K.

In some aspects, the server entity 200 determines whether or not the agent entities 300a:300K are to apply the transform Tₖ. Hence, in some embodiments, the server entity 200 is configured to perform (optional) step S108a as part of performing the iterative learning process in S108:

S108a:The server entity 200 provides an indication to the agent entities 300a:300K as to whether or not to apply the transform Tₖ when reporting the computational results of the computational task to the server entity 200.

The server entity 200 might base the decision as whether or not the agent entities 300a:300K are to apply the transform Tₖ based on different factors, such as capabilities of the agent entities 300a:300K (or of the user equipment 170a:170K in which the agent entities 300a:300K are provided), radio environment properties, and/or properties of the application for which the iterative learning process is used. In terms of capabilities of the agent entities 300a:300K, it could be that the some of the agent entities 300a:300K are only willing to participate in the iterative learning process in case there is a secure procedure for the agent entities 300a:300K to provide their model updates to the server entity 200. This might cause the server entity 200 to determine that the agent entities 300a:300K are to apply the transform Tₖ. In terms of radio environment properties, the sever entity 200 (or the network node 160) or any of the agent entities 300a:300K (or of the user equipment 170a:170K in which the agent entities 300a:300K are provided) might detects the presence of a jammer in the system. This might cause the server entity 200 to determine that the agent entities 300a:300K are to apply the transform Tₖ. Further in terms of radio environment properties, the sever entity 200 might be located in an area with high security requirements, for example a restricted area. This might cause the server entity 200 to determine that the agent entities 300a:300K are to apply the transform Tₖ. In terms of properties of the application for which the iterative learning process is used, the use of geolocation information can motivate using a secure iterative learning procedure (and hence cause the server entity 200 to determine that the agent entities 300a:300K are to apply the transform Tₖ), whilst only performing an iterative learning procedure with non-sensitive data, such as radio signal measurements, might be less sensitive (and hence not cause the server entity 200 to determine that the agent entities 300a:300K are to apply the transform Tₖ). In some examples, the agent entities 300a:300K are to always apply the transform Tₖ (unless instructed otherwise by the server entity 200).

Reference is now made to FIG. 6 illustrating a method for performing an iterative learning process with a server entity 200 as performed by the agent entity 300k according to an embodiment.

S202: The agent entity 300k obtains a secret key [symbol] that is associated with a computational task. The secret key [symbol] defines a transform Tₖ to be used by the agent entity 300k when reporting computational results of the computational task to the server entity 200.

S204: The agent entity 300k obtains configuring in terms of the computational task from the server entity 200.

S206: The agent entity 300k performs the iterative learning process with the server entity 200 until a termination criterion is met. The agent entity 300k as part of performing the iterative learning process applies the transform Tₖ to the computational results before sending the computational results to the server entity 200.

Embodiments relating to further details of performing an iterative learning process with a server entity 200 as performed by the agent entity 300k will now be disclosed.

In general terms, the embodiments, aspects, and example as disclosed above with reference to the server entity 200 apply equally to the agent entity 300k. But for completeness of this disclosure, some of the embodiments, aspects, and example as disclosed above are repeated hereinafter to be put in the context of the agent entity 300k.

The termination criterion in some non-limiting examples can be when a pre-determined number of iterations have been reached or when the computational results differ less than a threshold value from one iteration to the next.

Aspects of how the secret key [symbol] might be generated and shared will now be disclosed.

As disclosed above, in some embodiments, the secret key [symbol] is generated using a pseudo-random mechanism.

In some non-limiting examples, the secret key [symbol] is a function of any of: a pseudo-random number, identifiers of a user equipment 170k in which the agent entity 300k are provided, a time-stamp, or any combination thereof.

As disclosed above, in some embodiments, the secret key [symbol] is represented by a positive integer.

As disclosed above, the server entity 200 might configure the agent entities 300a:300K with the secret key [symbol] over a secure channel. Hence, in some embodiments, the secret key [symbol] is obtained from the server entity 200 over a secure channel established between the agent entity 300k and the server entity 200.

Aspects and properties of the transform Tₖ will now be disclosed.

As disclosed above, in some embodiments, the secret key [symbol] defines a sequential pattern of values to be applied by the agent entity 300k to the computational results, where the transform Tₖ is represented by the sequential pattern of values.

As disclosed above, in some embodiments, the transform Tₖ is represented by a matrix Lₖ, and the computational results are multiplied with the matrix Lₖ when the transform Tₖ is applied to the computational results.

As disclosed above, in some embodiments, the matrix Lₖ is a permutation matrix.

As disclosed above, in some embodiments, the matrix Lₖ is of size N×N and is generated as a function of the secret key [symbol] by setting element (n, [Ø (i)]ₙ)=1 in the matrix Lk, for n=1, . . . , N, and setting all other elements to 0.

As disclosed above, in some embodiments, the matrix Lₖ is an orthogonal matrix defined by the factor Q in a QR-factorization of a random matrix X. The random matrix X can be obtained through a pre-determined pseudo-random number generator seeded by the value of the secret key [symbol] , or alternatively, [symbol] mod I for some integer I that represents the largest possible seed value of the random number generator.

As disclosed above, in some embodiments, the transform Tₖ defines a sequence zₖ of pseudo-random noise, seeded by the secret key [symbol] , to be added to the computational results by the agent entity 300k.

Aspects of when the herein disclosed techniques for the agent entity 300k to be activated to transform the model updates will now be disclosed. In relation thereto, further aspects of the iterative learning process will also be disclosed. Intermediate reference is here made to the flowchart of FIG. 7 showing optional steps of one iteration of the iterative learning process that might be performed by the agent entity 300k during each iteration of the iterative learning process in S206.

S206b: The agent entity 300k obtains a parameter vector of the computational problem from the server entity 200.

S206c: The agent entity 300k determines the computational result of the computational task as a function of the obtained parameter vector for the iteration and of data locally obtained by the agent entity 300k.

S206d: The agent entity 300k obtains a transformed computational result by applying the transform Tₖ to the computational result.

S206e: The agent entity 300k reports the transformed computational result to the server entity 200.

As disclosed above, in some aspects, the secret key [symbol] is changed over time from one iteration of the iterative learning process to the next. Hence, in some embodiments, the agent entity 300k is configured to perform (optional) step S206f as part of performing the iterative learning process in S206:

S206f: The agent entity 300k obtains an update of the secret key [symbol] for a next iteration of the iterative learning process, whereby a new transform is defined.

As disclosed above, in some embodiments, the secret key [symbol] is updated according to a pre-determined schedule known to the agent entity 300k and the server entity 200.

As disclosed above, in some aspects, the server entity 200 determines whether or not the agent entities 300a:300K are to apply the transform Tₖ. Hence, in some embodiments, the agent entity 300k is configured to perform (optional) step S206a as part of performing the iterative learning process in S206:

S206f: The agent entity 300k obtains an indication from the server entity 200 as to whether or not to apply the transform Tₖ when reporting the computational results of the computational task to the server entity 200.

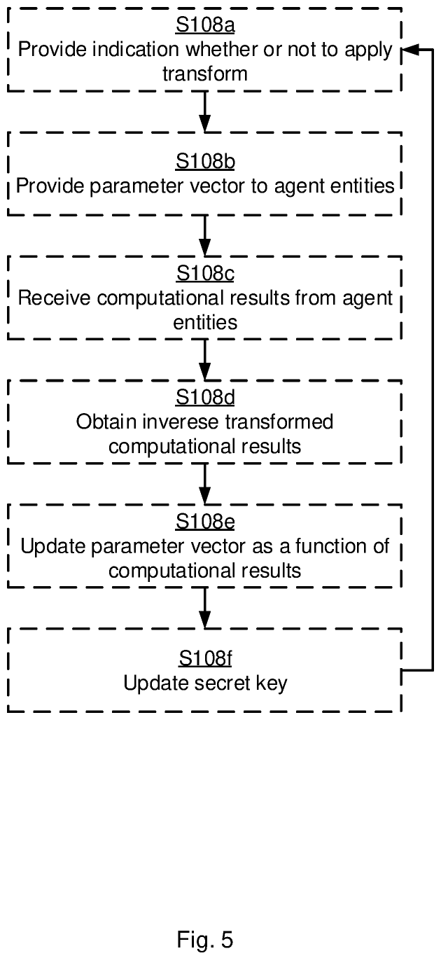

One particular embodiment of performing an iterative learning process with agent entities 300a:300K as performed by the server entity 200 and of performing an iterative learning process with a server entity 200 as performed by the agent entity 300k based on at least some of the above disclosed embodiments will now be disclosed in detail with reference to the signalling diagram of FIG. 8. For simplicity of exposition, we consider a system with one server entity 200 and two agent entities 300a, 300b (k=1, 2). The extension to an arbitrary number of agent entities 300a:300K should be clear to the skilled person in the art.

S300: The server entity 200 maintains a global model, defined by parameter vector θ.

S301a, S301b: The server entity 200 provides both agent entities 300a, 300b with a shared secret key [symbol] over a secure channel.

S302a, S302b: The server entity 200 broadcasts the current parameter vector θ to the agent entities 300a, 300b.

S303a, S303b: Each agent entity 300a, 300b performs a local optimization of the model by running T steps of a stochastic gradient descent update on θ(i), based on its local training data to obtain a model update. Specifically, the k:th agent obtains a gradient update δₖ of the model global θ.

S304a, S304b: Agent k applies a pre-determined function to the secret key [symbol] and the agent index k in order to determine a transform Tₖ.

S305a, S305b: Each agent entity 300a, 300b applies the transform Tₖ to their N-dimensional gradient update vector δₖ. The k:th agent then transmits the transformed gradient update vector δ′ₖ=Tₖ(δₖ).

S306: The server entity 200, receiving the aggregated message δ′₁+δ′₂ and knowing the key [symbol] , inverts the message to recover δ₁+δ₂. The server entity 200 then updates the global model by means of the parameter vector θ, and checks if a pre-determined stopping criterion is satisfied. If not satisfied, then the method is repeated from steps S302a, S302b.

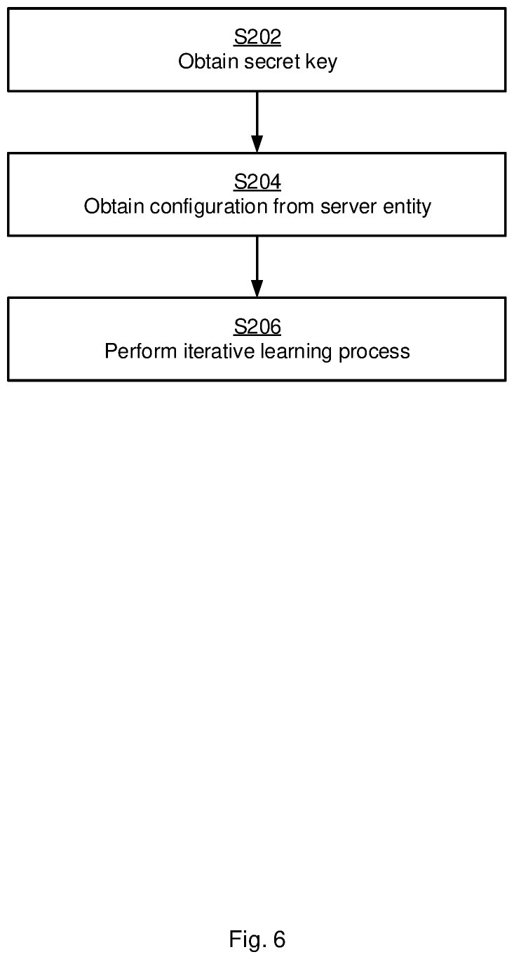

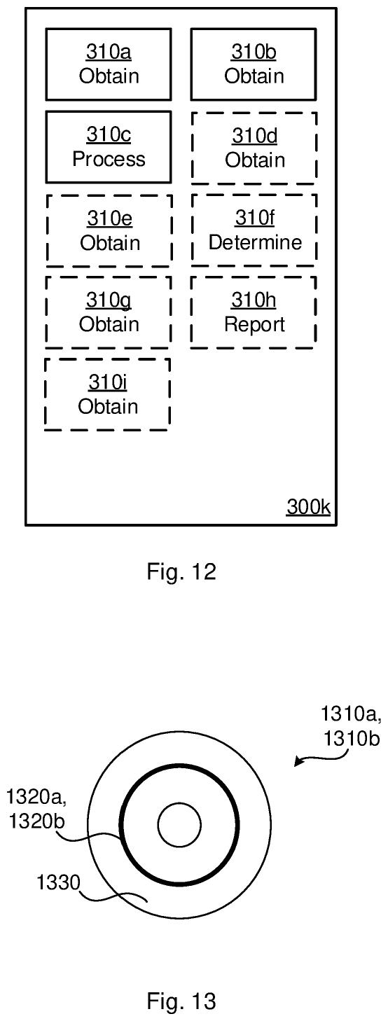

FIG. 9 schematically illustrates, in terms of a number of functional units, the components of a server entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1310a (as in FIG. 13), e.g. in the form of a storage medium 230. The processing circuitry 210 may further be provided as at least one application specific integrated circuit (ASIC), or field programmable gate array (FPGA).

Particularly, the processing circuitry 210 is configured to cause the server entity 200 to perform a set of operations, or steps, as disclosed above. For example, the storage medium 230 may store the set of operations, and the processing circuitry 210 may be configured to retrieve the set of operations from the storage medium 230 to cause the server entity 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The server entity 200 may further comprise a communications interface 220 for communications with other entities, functions, nodes, and devices, either directly or indirectly. As such the communications interface 220 may comprise one or more transmitters and receivers, comprising analogue and digital components.

The processing circuitry 210 controls the general operation of the server entity 200 e.g. by sending data and control signals to the communications interface 220 and the storage medium 230, by receiving data and reports from the communications interface 220, and by retrieving data and instructions from the storage medium 230. Other components, as well as the related functionality, of the server entity 200 are omitted in order not to obscure the concepts presented herein.

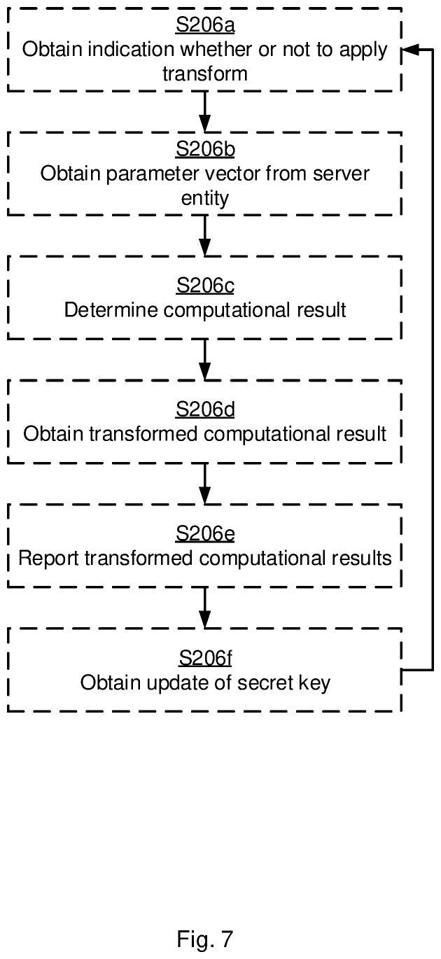

FIG. 10 schematically illustrates, in terms of a number of functional modules, the components of a server entity 200 according to an embodiment. The server entity 200 of FIG. 10 comprises a number of functional modules; an associate module 210a configured to perform step S102, a configure module 210b configured to perform step S104, and a process module 210d configured to perform step S108. The server entity 200 of FIG. 10 may further comprise a number of optional functional modules, such as any of a configure module 210c configured to perform step S106, a provide module 210e configured to perform step S108a, a provide module 210f configured to perform step S108b,a receive module 210g configured to perform step S108c, an obtain module 210h configured to perform step S108d, an update module 210i configured to perform step S108e, and an update module 210j configured to perform step S108f. In general terms, each functional module 210a:210j may be implemented in hardware or in software. Preferably, one or more or all functional modules 210a:210j may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210j and to execute these instructions, thereby performing any steps of the server entity 200 as disclosed herein.

The server entity 200 may be provided as a standalone device or as a part of at least one further device. Thus, a first portion of the instructions performed by the server entity 200 may be executed in a first device, and a second portion of the instructions performed by the server entity 200 may be executed in a second device; the herein disclosed embodiments are not limited to any particular number of devices on which the instructions performed by the server entity 200 may be executed. Hence, the methods according to the herein disclosed embodiments are suitable to be performed by a server entity 200 residing in a cloud computational environment. Therefore, although a single processing circuitry 210 is illustrated in FIG. 9 the processing circuitry 210 may be distributed among a plurality of devices, or nodes. The same applies to the functional module 210a:210j of FIG. 10 and the computer program 1320a of FIG. 13.

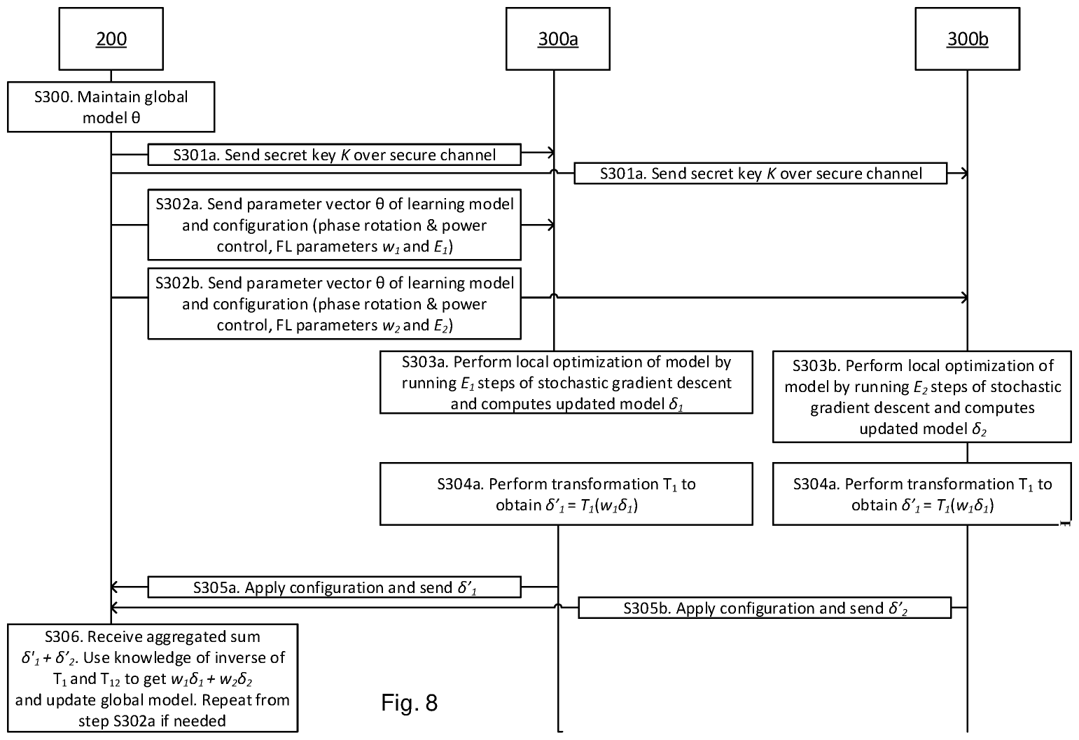

FIG. 11 schematically illustrates, in terms of a number of functional units, the components of an agent entity 300k according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1310b (as in FIG. 13), e.g. in the form of a storage medium 330. The processing circuitry 310 may further be provided as at least one application specific integrated circuit (ASIC), or field programmable gate array (FPGA).

Particularly, the processing circuitry 310 is configured to cause the agent entity 300k to perform a set of operations, or steps, as disclosed above. For example, the storage medium 330 may store the set of operations, and the processing circuitry 310 may be configured to retrieve the set of operations from the storage medium 330 to cause the agent entity 300k to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The agent entity 300k may further comprise a communications interface 320 for communications with other entities, functions, nodes, and devices, either directly or indirectly. As such the communications interface 320 may comprise one or more transmitters and receivers, comprising analogue and digital components.

The processing circuitry 310 controls the general operation of the agent entity 300k e.g. by sending data and control signals to the communications interface 320 and the storage medium 330, by receiving data and reports from the communications interface 320, and by retrieving data and instructions from the storage medium 330. Other components, as well as the related functionality, of the agent entity 300k are omitted in order not to obscure the concepts presented herein.

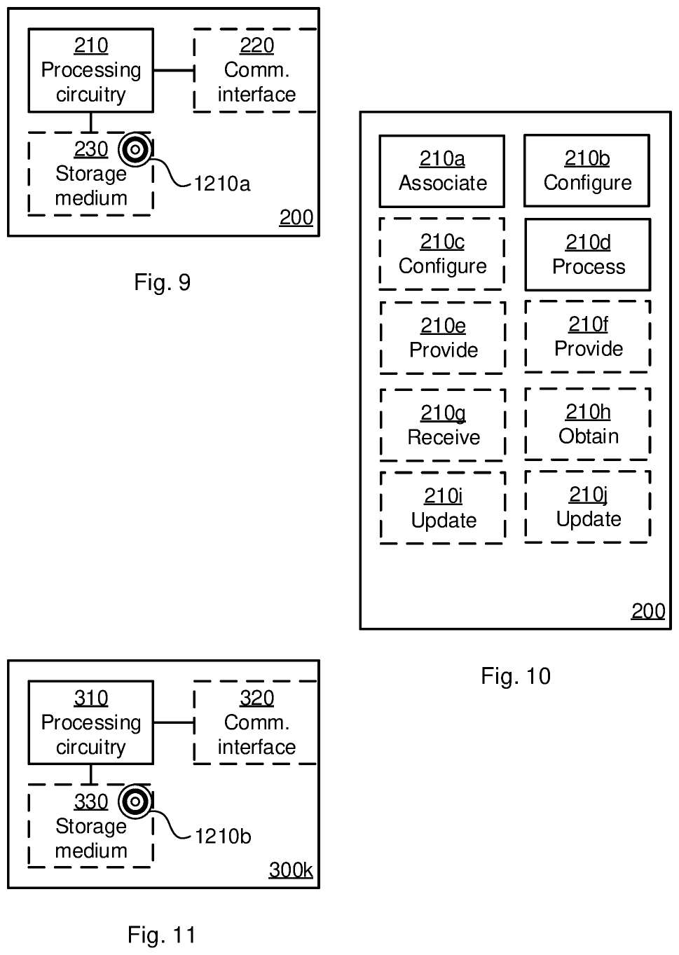

FIG. 12 schematically illustrates, in terms of a number of functional modules, the components of an agent entity 300k according to an embodiment. The agent entity 300k of FIG. 12 comprises a number of functional modules; an obtain module 310a configured to perform step S202, an obtain module 310b configured to perform step S204, and a process module 310c configured to perform step S206. The agent entity 300k of FIG. 12 may further comprise a number of optional functional modules, such as any of an obtain module configured to perform step S206a, an obtain module configured to perform step S206b, a determine module configured to perform step S206c, an obtain module configured to perform step S206d, a report module configured to perform step S206e, and an obtain module configured to perform step S206f.

In general terms, each functional module 310a:310i may be implemented in hardware or in software. Preferably, one or more or all functional modules 310a:310i may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310i and to execute these instructions, thereby performing any steps of the agent entity 300k as disclosed herein.

The agent entity 300k may be provided as a standalone device or as a part of at least one further device. Thus, a first portion of the instructions performed by the agent entity 300k may be executed in a first device, and a second portion of the instructions performed by the agent entity 300k may be executed in a second device; the herein disclosed embodiments are not limited to any particular number of devices on which the instructions performed by the agent entity 300k may be executed.

Hence, the methods according to the herein disclosed embodiments are suitable to be performed by an agent entity 300k residing in a cloud computational environment. Therefore, although a single processing circuitry 310 is illustrated in FIG. 11 the processing circuitry 310 may be distributed among a plurality of devices, or nodes. The same applies to the functional module 310a:310i of FIG. 12 and the computer program 1320b of FIG. 13.

FIG. 13 shows one example of a computer program product 1310a, 1310b comprising computer readable means 1330. On this computer readable means 1330, a computer program 1320a can be stored, which computer program 1320a can cause the processing circuitry 210 and thereto operatively coupled entities and devices, such as the communications interface 220 and the storage medium 230, to execute methods according to embodiments described herein. The computer program 1320a and/or computer program product 1310a may thus provide means for performing any steps of the server entity 200 as herein disclosed. On this computer readable means 1330, a computer program 1320b can be stored, which computer program 1320b can cause the processing circuitry 310 and thereto operatively coupled entities and devices, such as the communications interface 320 and the storage medium 330, to execute methods according to embodiments described herein. The computer program 1320b and/or computer program product 1310b may thus provide means for performing any steps of the agent entity 300k as herein disclosed.

In the example of FIG. 13, the computer program product 1310a, 1310b is illustrated as an optical disc, such as a CD (compact disc) or a DVD (digital versatile disc) or a Blu-Ray disc. The computer program product 1310a, 1310b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320a, 1320b is here schematically shown as a track on the depicted optical disk, the computer program 1320a, 1320b can be stored in any way which is suitable for the computer program product 1310a, 1310b.

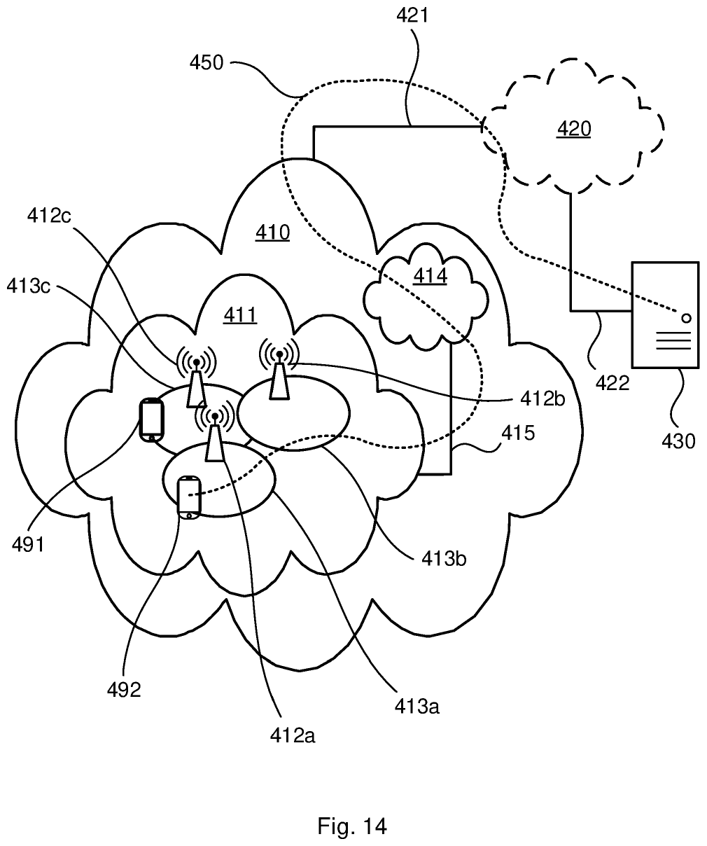

FIG. 14 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 160 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to UEs 170a:17oK of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 14 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

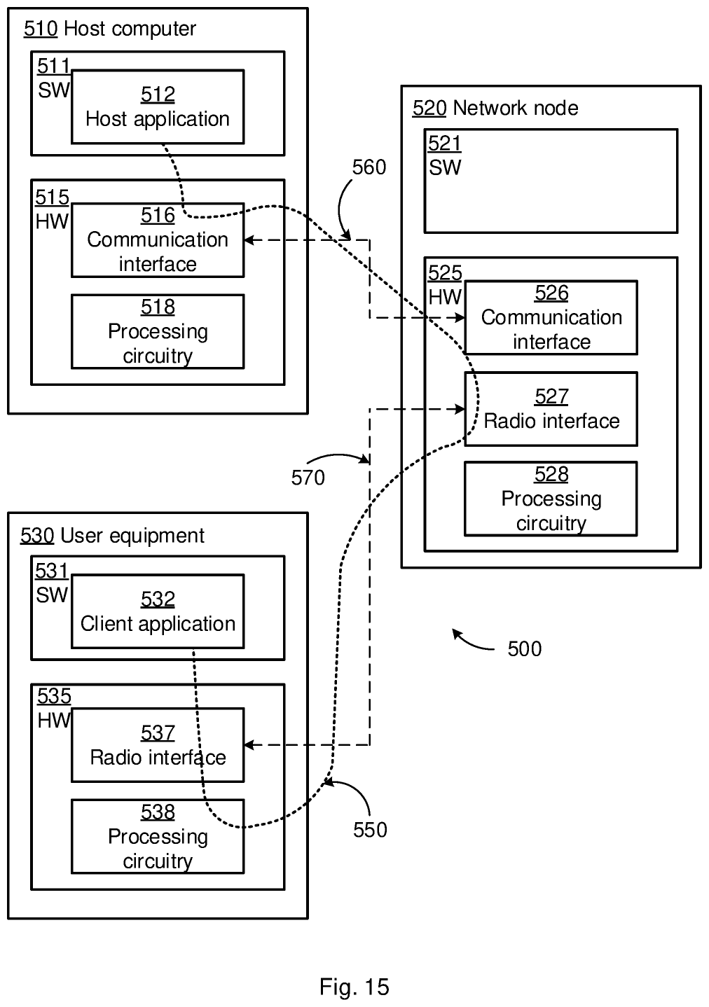

FIG. 15 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 15. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the UEs 170a:17oK of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 160 of FIG.

1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 15) served by radio access network node 520. Communication interface 526 may be configured to facilitate connection 560 to host computer 510. Connection 560 may be direct or it may pass through a core network (not shown in FIG. 15) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 15 may be similar or identical to host computer 430, one of network nodes 412a, 412b, 412c and one of UEs 491, 492 of FIG. 14, respectively. This is to say, the inner workings of these entities may be as shown in FIG. 15 and independently, the surrounding network topology may be that of FIG. 14.

In FIG. 15, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signalling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-44. (canceled)

45. A method for performing an iterative learning process with agent entities, the method being performed by a server entity, the method comprising:
associating a secret key [symbol] with a computational task, wherein the secret key [symbol] defines a transform Tₖ to be used by the agent entities when reporting computational results of the computational task to the server entity, and wherein the transform Tₖ has an inverse Tₖ⁻¹;
configuring the agent entities with the computational task; and
performing the iterative learning process with the agent entities until a termination criterion is met, wherein the server entity as part of performing the iterative learning process applies the inverse Tₖ⁻¹ of the transform Tₖ to the computational results received from the agent entities.

46. The method according to claim 45, wherein the method further comprises configuring the agent entities with the secret key [symbol] over a secure channel established between the server entity and the agent entities.

47. The method according to claim 45, wherein the secret key [symbol] is a function of any one or more of: a pseudo-random number, identifiers of user equipment in which the agent entities are provided, randomness extracted from hardware of a network node in which the server entity is provided, or a time-stamp.

48. The method according to claim 45, wherein the secret key [symbol] defines a sequential pattern of values to be applied by the agent entities to the computational results, and wherein the transform Tₖ is represented by the sequential pattern of values.

49. The method according to claim 45, wherein the transform Tₖ is represented by a matrix Lₖ having an inverse Lₖ⁻¹, and wherein the computational results received from the agent entities are multiplied with the inverse Lₖ⁻¹ of the matrix Lₖ when the inverse Tₖ⁻¹ of the transform Tₖ is applied to the computational results.

50. The method according to claim 45, wherein the transform Tₖ is the same for all the agent entities.

51. The method according to claim 45, wherein the transform Tₖ defines a sequence zₖ of pseudo-random noise, seeded by the secret key [symbol] , to be added to the computational results by the agent entities, wherein the sequence zₖ of pseudo-random noise for a first of the agent entities and for a second of the agent entities have identical values but with opposite signs, and wherein the sequences zₖ of pseudo-random noise for all the agent entities sum to zero.

52. The method according to claim 45, wherein the server entity during each iteration of the iterative learning process:
provides a parameter vector of the computational task to the agent entities;
receives the computational results as a function of the parameter vector from the agent entities;
obtains inverse transformed computational results by applying the inverse Tₖ⁻¹ of the transform Tₖ to the computational results; and
updates the parameter vector as a function of an aggregate of the inverse transformed computational results.

53. The method according to claim 45, wherein the method further comprises updating the secret key [symbol] for a next iteration of the iterative learning process, whereby a new transform is defined, the new transform having a new inverse.

54. The method according to claim 45, further comprising updating the secret key [symbol] according to a pre-determined schedule known to the server entity and the agent entities.

55. The method according to claim 45, wherein the method further comprises providing an indication to the agent entities as to whether or not to apply the transform Tₖ when reporting the computational results of the computational task to the server entity.

56. The method according to claim 45, wherein the server entity is provided in a network node, and each of the agent entities is provided in a respective user equipment.

57. A method for performing an iterative learning process with a server entity, the method being performed by an agent entity, the method comprising:
obtaining a secret key [symbol] that is associated with a computational task, wherein the secret key [symbol] defines a transform Tₖ to be used by the agent entity when reporting computational results of the computational task to the server entity;
obtaining configuring in terms of the computational task from the server entity; and
performing the iterative learning process with the server entity until a termination criterion is met, wherein the agent entity as part of performing the iterative learning process applies the transform Tₖ to the computational results before sending the computational results to the server entity.

58. The method according to claim 57, wherein obtaining the secret key [symbol] comprises obtaining the secret key [symbol] from the server entity over a secure channel established between the agent entity and the server entity.

59. The method according to claim 57, wherein the agent entity during each iteration of the iterative learning process:
obtains a parameter vector of the computational problem from the server entity;
determines the computational result of the computational task as a function of the obtained parameter vector for the iteration and of data locally obtained by the agent entity;
obtains a transformed computational result by applying the transform Tₖ to the computational result; and
reports the transformed computational result to the server entity.

60. The method according to claim 57, wherein further comprising obtaining an update of the secret key [symbol] for a next iteration of the iterative learning process, whereby a new transform is defined.

61. The method according to claim 57, further comprising updating the secret key [symbol] according to a pre-determined schedule known to the agent entity and the server entity.

62. The method according to claim 57, wherein the method further comprises obtaining an indication from the server entity as to whether or not to apply the transform Tₖ when reporting the computational results of the computational task to the server entity.

63. A server entity comprising:
a communications interface configured for direct or indirect communications with agent entities; and
processing circuitry operative to perform an iterative learning process with the agent entities, based on the processing circuitry being configured to cause the server entity to:
associate a secret key [symbol] with a computational task, wherein the secret key [symbol] defines a transform Tₖ to be used by the agent entities when reporting computational results of the computational task to the server entity, and wherein the transform Tₖ has an inverse Tₖ⁻¹;
configure the agent entities with the computational task; and
perform the iterative learning process with the agent entities until a termination criterion is met, wherein the server entity as part of performing the iterative learning process applies the inverse Tₖ⁻¹ of the transform Tₖ to the computational results received from the agent entities.

64. An agent entity comprising:
a communications interface configured for direct or indirect communications with a server entity; and
processing circuitry operative to perform an iterative learning process with the server entity, based on the processing circuitry being configured to cause the agent entity to:
obtain a secret key [symbol] that is associated with a computational task, wherein the secret key [symbol] defines a transform Tₖ to be used by the agent entity when reporting computational results of the computational task to the server entity;
obtain configuring in terms of the computational task from the server entity; and
perform the iterative learning process with the server entity until a termination criterion is met, wherein the agent entity as part of performing the iterative learning process applies the transform Tₖ to the computational results before sending the computational results to the server entity.
